(19) United States
(12) Patent Application Publication
(10) Pub. No.: US 2025/0319618 A1
(43) Pub. Date: Oct. 16, 2025

(54) Apparatus, device, and method for powering portable hair trimmer with an external power source such as a mobile phone

(71) Applicant: Vladislav Kofman, Brooklyn, NY (US)

(72) Inventor: Vladislav Kofman, Brooklyn, NY (US)

(73) Assignee: Cardinalis Group Inc., Brooklyn, NY (US)

(21) Appl. No.: 18/634,534

(22) Filed: Apr. 12, 2024

(51) Int. Cl. B26B 19/38; B26B 19/14

(52) U.S. Cl. CPC B26B 19/388; B26B 19/148; B26B 19/3853

(57) ABSTRACT

The invention is a portable electric battery-less hair trimmer, which does not contain an internal power source and can be used with and powered by a mobile device, such as a mobile phone or similar device capable of providing electric power output. It belongs to the field of personal portable hair trimming or hair clipping devices, particularly devices for precise and safe hair removal from the nostrils, eyebrows, ears, and other facial areas. One embodiment is a device that is a small portable, wireless version comprising a trimming top part, enclosing stainless steel blades, and a main body section enclosing an electric motor and having an exterior power connector. The device incorporates safety features, ergonomic design, and waterproof capabilities. This patent application outlines the unique aspects of the invention.

### FIELD OF INVENTION

The present disclosure relates to the technical field of personal care products, in particular hair trimmers. Specifically, the field of devices and processes used for hair cutting, such as appliances and hand-held cutting tools, and other equipment for cosmetics, hygiene, hair trimming, or grooming.

### BACKGROUND

Conventional personal hair trimmers are commonly used grooming tools for maintaining personal hygiene, for trimming nose, ear, eyebrows, or other facial hair areas. Such conventional personal hair trimmers are mostly electric and have rotating blades and an electric motor. There are two main versions of the electric hair trimmers, wired and wireless. Purely mechanical versions exist as well, where users apply physical force to manually rotate the internal blades, utilizing a spring and a ratchet mechanism.

The electric wireless personal hair trimmers unitize an internal power source to convert electric energy into rotational mechanical energy, using an electric motor, to rotate internal blades. Thus, the electric wireless personal hair trimmers must contain an internal power source to supply the electric motor with power. Having an internal power source in an electric wireless personal hair trimmer requires users to maintain a certain level of power within the device for it to be operational. The conventional internal power source is either a rechargeable battery such as lithium-ion (Li-ion), zinc-ion, sodium-ion, lithium-sulfur or solid-state batteries which need to be periodically charged, or a non-rechargeable battery, such as alkaline batteries, which need to be periodically replaced.

In the mechanical-only versions, the rotation speed is slow and cannot match electric versions and requires users to exert force to perform a trimming operation.

In the wired electric versions of the device, there is no convenience of the wireless operation, although the blade rotation speed would match the wireless options.

Therefore, a need exists for a personal wireless hair trimmer that does not contain an internal power source, yet can match the performance of an electric trimmer, does not require a manual application of force, and can use an external wireless power source, such as ubiquitous conventional personal mobile devices e.g. mobile phones or tablets. This invention is an electric personal hair trimmer which provides this need.

### DETAILED DESCRIPTION OF THE INVENTION

Described herein is the wireless electric device for personal hair grooming, which cuts hairs using a set of hypoallergenic stainless-steel blades in a compact and convenient grooming tool form-factor designed for precise hair removal from the nose, ears, eyebrows, beard, and other facial areas. More specifically a personal portable hair trimmer with an integrated catch bin, used in conjunction with a mobile phone (or similar device) to power the electric motor and the blade rotation function and provide a convenient wireless operation, by directly attaching to the mobile phone. The device itself does not contain an internal power source such as a rechargeable or non-rechargeable battery. This invention is not a mechanical hair trimmer as it contains an electric motor.

The easy handling operation of the device can be one-handed, and the user can hold the mobile phone itself while operating the device.

The portable electric nose hair trimmer described herein comprises the following components: the enclosing part for the hypoallergenic stainless-steel blades mechanism, and hair catch bin, the part for enclosing the electric motor and the relay electronics board to control the electric motor, and the wiring to connect to the mobile power source industry standard Universal Serial Bus (USB) type connector.

The USB plug in the current embodiment of the invention described, uses USB Type-C® and USB-C® connection and the corresponding protocol for power delivery, other embodiments may use similar Universal Serial Bus (USB) power delivery protocols but via different USB connectors. The sole purpose of the plug is to connect the device to the external power source, such as a mobile phone supporting the power output required.

It is accordingly the goals of this detailed description of the invention to cover a device having all of the advantages and benefits set forth above and described in greater detail hereinafter in this application.

This version of the hair trimmer is remarkably simple in its structure so it is economical to manufacture and does not require lithium-ion researchable batteries or any kind of chemically based batteries internally. In one embodiment of the invention, the rigid structure enclosing the electric motor, relay electronics, required wiring, and control module may be formed of molded plastic, metal, or similar rigid materials, and would be completely sealed and waterproof. The part used to cut hair can also be molded from high-grade plastic, metal, or similar rigid materials, would be removable for washing, and would enclose the cutting mechanism and catch hairs. The blades, which are part of the cutting mechanism would be made from hypoallergic stainless steel, to maintain a sharp edge and have adequate resistance to rust and corrosion.

In the current embodiment of the invention, the device does not have an On/Off button (used to turn on the device). Instead, the action of plugging or unplugging the device to or from the mobile power source (such as a mobile phone or similar power device) can itself be equivalent to turning the device On or Off, without the need for the user to press any buttons.

This invention and description also comprise other capabilities related to this type of device, without an internal power source, as may later fully appear and which are inherently possessed by the invention. The one preferred embodiment described herein is primarily a hair-trimming device, but other grooming applications are possible.

### DESCRIPTION OF THE DRAWINGS

While the accompanying drawings demonstrate the preferred embodiment of the invention, it should be understood that the same is susceptible to modification and change without departing from the spirit of the invention, such as a change in the shape of the motor enclosing part, or power delivery protocol.

The drawings are not to exact scale. The drawings are not intended to portray specific sizes or parameters of the parts of the invention and should be considered merely representations. The drawings are intended to depict example embodiments of the invention, and therefore should not be considered as limiting in scope, but represent the essence of the invention. In the drawings, the same numbering may represent like elements. Furthermore, certain elements in some of the figures may be not labeled due to overlay with other depicted elements, or depicted not-to-scale, for explanatory clarity only.

FIG. 1 is a complete exterior view of the embodiment of the invention showing the hair trimmer wireless device. Showing the device in its entirety, and depicts the part enclosing the cutting mechanism and catch bin, the part enclosing the electric motor, and the power plug.

FIG. 2 is a complete internal view and structure of the embodiment of the invention showing, the hair trimmer assembly mechanism, hypoallergenic stainless-steel blades and catch bin, and internal structure showing motor, relay electronics, and power plug, as separate parts.

FIG. 3A detailed view of the hair trimmer assembly mechanism, with hypoallergenic stainless-steel blades.

### DESCRIPTION OF THE PREFERRED EMBODIMENT

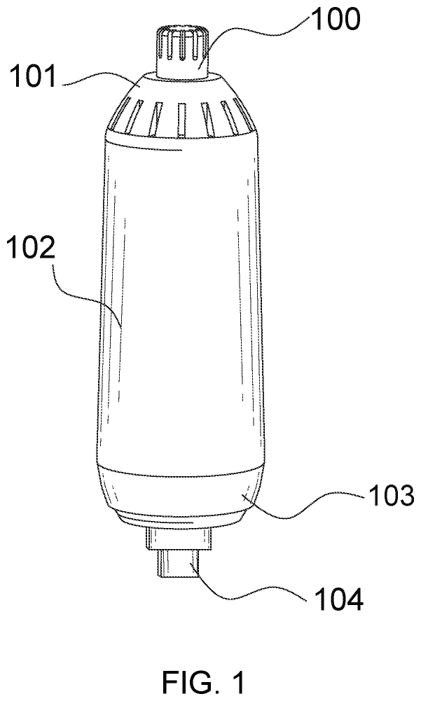

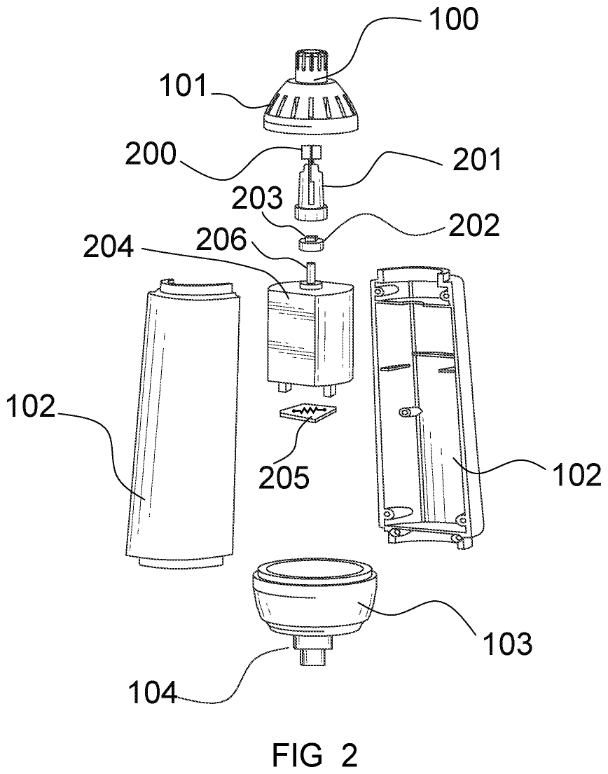

Referring to FIG. 1 and FIG. 2 of the drawings, the device works by using electric energy to rotate a set of hypoallergenic stainless-steel blades 200, inside of a protruding tube-like structure with slots 100, which is part of the catch bin part 101. The device body comprises a bar-shaped elongated part 102 which encloses an electric motor 204, relay electronic board 205, required wiring, and the bottom enclosure part 103, with integrated power plug or connector 104, for attaching to the mobile power source, such as the mobile phone. The motor operates at a low noise level (less than 60 dB) for a comfortable grooming experience. The elongated part enclosing cutting blades 200, having a protruding tube-like structure with slots 100 provides a narrow profile for safe and comfortable trimming within the nasal cavity. The integrated catch bin is part of the whole assembly 101, which attaches to the body enclosing the motor 102.

The part enclosing the motor and required wiring 102 is molded from a rigid material, such as hard plastic, and the bottom of the device 103 has the integrated power plug or connector 104, protruding for a convenient way to connect to the external power source. The connector 104 is compatible with separate power sources, such as, but not limited to USB (e.g. USB-C®) connectors.

In the preferred embodiment, motor 204 is controlled by the relay electrics board 205, without an on/off switch, which controls and sets the rotation speed to the required setting and provides a power draw and speed. The draw of power from the external power source is consistent and is not affected by the external mobile power source battery levels or remaining life. The device is designed to work for as long as an external power source can deliver power.

The connector (power plug) 104 protruding from the bottom section of the device 103, is plugged into the mobile phone and securely holds the entire device in place. The connection is the USB industry standard connector.

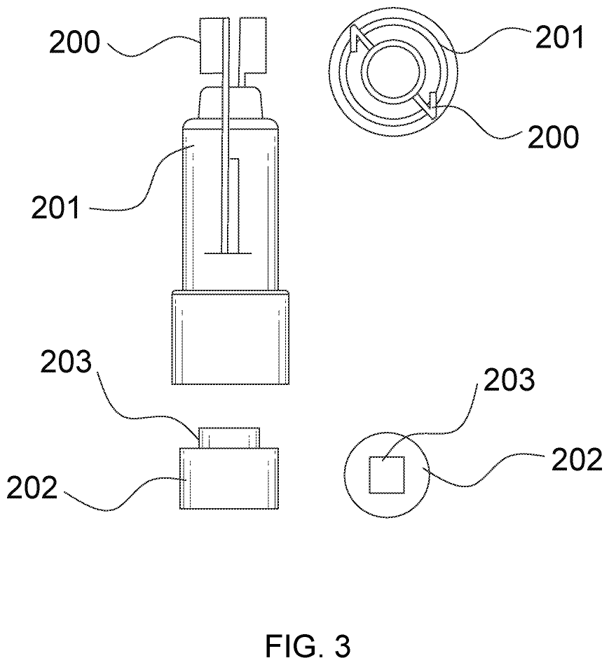

Referring to FIG. 3 of the drawings, which depict side and top views of the blade assembly mechanism 201, where a set of hypoallergenic stainless-steel cutter blades 200 are positioned in such a way as to be easily inserted into the protruding tube-like structure with slots 100, to create a cutting action, when the hair(s) is placed in the slots, between the blade and the outer wall of the protruding tube-like structure 100. There is no direct contact with the skin by the blades. If the blades are obstructed (sudden stop), the motor will stop automatically as a built-in safety mechanism to prevent discomfort to the user.

The cutting mechanism assembly with the stainless-steel blades 201 is attached to the electric motor shaft 206, via a separate part 202 permanently attached to the motor shaft 206 with a square-shaped pin or peg 203, (or a similar polygonal shape peg). The peg 203 is designed to be inserted into the same shape socket which would ensure a latch, and a secure coupling to the blade's assembly part 201. The pin 203 and socket 201 coupling is a parallel, same torque, perfectly aligned rigid coupling, to allow minimal power transmission loss, to maximize rotation efficiency, and protect parts from normal wear and tear. Given that the coupling part 202 with pin 203 is permanently attached to the electric motor shaft 206, the part enclosing motor 102 is sealed and provides an air gap with water and dust protection for motor 204 and electronics 205 inside. The hair trimmer device remains functional even when exposed to water.

The current illustrations are intended to represent the one embodiment of the invention without departing from the spirit, scope, and purpose of the invention. Thus, it is intended that the present invention cover the modifications and variations of this invention provided they come within the scope of the appended claims and their equivalents.

The portable wireless electric nose hair trimmer with integrated catch bin described herein offers a convenient, hygienic, and user-friendly solution for personal nose hair trimming, without the need to change or replace batteries or use physical force. The invention combines portability with features that address common drawbacks of existing nose hair trimmers. Its unique features make it an ideal choice for personal grooming. The trimmer's compact size and battery-less operated functionality make it ideal for travel and on-the-go use. Reference will now be made to the claims of the invention.

1. A portable electric battery-less hair trimmer, with no independent internal power source, powered via an external power source such as a mobile phone.

2. The hair trimmer of claim 1, which provides a cordless operation by being attached to draw power from an external power source such as a mobile phone.

3. The hair trimmer of claim 1, which provides unlimited continuous usage for as long as external power source allows.

4. The hair trimmer of claim 1, with a blade assembly and a safety feature such as blocking protection (sudden stop).

5. The hair trimmer of claim 1, with an ergonomic design with an approximate length of 2.5 inches.

6. The hair trimmer of claim 1, with an IPX-7 waterproof rating.

7. The hair trimmer of claim 1, having a motor with a noise level of less than 60 dB.
